(19) United States
(12) Patent Application Publication
(10) Pub. No.: US 2026/0292553 A1
(43) Pub. Date: Sep. 24, 2026

(54) METHODS AND APPARATUSES FOR ENHANCEMENTS ON CONNECTED MODE MEASUREMENTS IN GLOBAL NAVIGATION SATELLITE SYSTEM OPERATION

(71) Applicant: MEDIATEK INC., Hsinchu City (TW)

(72) Inventor: Hsuan-Li LIN, Hsinchu City (TW)

(73) Assignee: MEDIATEK INC., Hsinchu City (TW)

(21) Appl. No.: 19/473,789

(22) PCT Filed: Oct. 30, 2024
(86) PCT No.: PCT/CN2024/128333

§ 371 Date: Oct. 8, 2025

Related U.S. Application Data
(60) Provisional application No. 63/595,782, filed on Nov. 3, 2023.

(51) Int. Cl. H04W 24/08; H04W 84/06

(52) U.S. Cl. CPC H04W 24/08; H04W 84/06

(57) ABSTRACT

Various solutions for enhancements on connected mode measurements in global navigation satellite system (GNSS) operation are described. An apparatus may connect to a serving cell associated with a first non-geostationary orbit (NGSO) satellite to operate in a connected mode. The apparatus may also receive a configuration of one or more neighbor cells associated with a second NGSO satellite from the serving cell. The serving cell and the one or more neighbor cells are operating in a same frequency band. Then, the apparatus may perform an intra-frequency measurement on the one or more neighbor cells based on the configuration in an event that at least one condition is met.

### CROSS REFERENCE TO RELATED PATENT APPLICATION(S)

The present disclosure is part of a non-provisional application claiming the priority benefit of U.S. Patent Application No. 63/595,782, filed 3 Nov. 2023, the content of which herein being incorporated by reference in its entirety.

### TECHNICAL FIELD

The present disclosure is generally related to mobile communications and, more particularly, to enhancements on connected mode measurements in global navigation satellite system (GNSS) operation.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, non-terrestrial network (NTN) is introduced as a terminal-satellite direct communication technology based on the new radio (NR) interface. With the integration of satellite network and ground cellular network (e.g., 5th generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

In 3GPP Release 18, connected mode measurement is support for IoT NTN. However, in GNSS such as a non-geostationary orbit (NGSO) satellite system, the large time delay and Doppler frequency shift may result in situation that the serving satellite and the neighbor satellite operating in the same frequency band may be detected at the UE as satellites in different frequency bands. Consequently, for NTN NGSO intra-frequency measurement on the neighbor cell associated with different NGSO satellite, the UE may not be able to measure the cells on both the serving satellite and the neighbor satellite at one time. Moreover, the measurement behavior is undefined or unclear for the case where the GNSS measurement gap is configured. According to current 3GPP Release 18 standards, all radio link monitoring (RLM) or radio resource management (RRM) measurements need to be suspended during the GNSS measurement gap even if (re) acquisition of the GNSS position fix has been completed. Since the GNSS measurement gap configurable by network may be up to 30 seconds, the UE may be unnecessarily held up from performing RLM/RRM measurements for a long time, which is detrimental to overall system efficiency.

Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhancements on connected mode measurements in GNSS operation. It is believed that the above-described issue would be avoided or otherwise alleviated by implementing one or more of the proposed schemes described herein.

In one aspect, a method may involve an apparatus connecting to a serving cell associated with a first NGSO satellite to operate in a connected mode. The method may also involve the apparatus receiving a configuration of one or more neighbor cells associated with a second NGSO satellite from the serving cell, wherein the serving cell and the one or more neighbor cells are operating in a same frequency band. The method may further involve the apparatus performing an intra-frequency measurement on the one or more neighbor cells based on the configuration in an event that at least one condition is met.

In one aspect, an apparatus may comprise a transceiver which, during operation, wirelessly communicates with one or more cells. The apparatus may also comprise a processor communicatively coupled to the transceiver. The processor, during operation, may perform operations comprising connecting, via the transceiver, to a serving cell associated with a first NGSO satellite to operate in a connected mode. The processor may also perform operations comprising receiving, via the transceiver, a configuration of one or more neighbor cells associated with a second NGSO satellite from the serving cell, wherein the serving cell and the one or more neighbor cells are operating in a same frequency band. The processor may further perform operations comprising performing, via the transceiver, an intra-frequency measurement on the one or more neighbor cells based on the configuration in an event that at least one condition is met.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of Doppler frequency shift in NTN system.

FIG. 2 is a diagram depicting an example scenario of a communication environment in which various solutions and schemes in accordance with the present disclosure may be implemented.

FIG. 3 is a diagram depicting an example scenario of intra-frequency inter-satellite measurement in accordance with an implementation of the present disclosure.

FIG. 4 is a diagram depicting an example scenario of early termination of GNSS measurement gap in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on connected mode measurements in GNSS operation. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites (i.e., NGSO satellites) or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

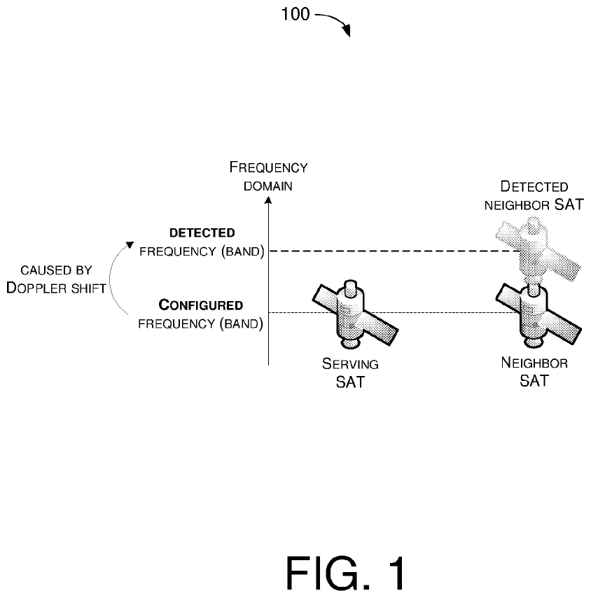

In NTN system (e.g., IoT NTN system), due to large time delay and Doppler frequency shift, the serving satellite and the neighbor satellite operating in the same frequency band may be detected at the UE as satellites in different frequency bands, as shown in FIG. 1. As a result, for NTN NGSO intra-frequency measurement on the neighbor cell associated with different NGSO satellite, the UE may not be able to measure the cells on both the serving satellite and the neighbor satellite at one time. Thus, the UE may need new designs for intra-frequency inter-satellite neighbor cell measurements. Furthermore, the measurement behavior is undefined or unclear for the case where the GNSS measurement gap is configured. According to current 3GPP Release 18 standards, all RLM/RRM measurements need to be suspended during the GNSS measurement gap even if (re) acquisition of the GNSS position fix has been completed. Since the GNSS measurement gap configurable by network may be up to 31 seconds, the UE may be unnecessarily held up from performing RLM/RRM measurements for a long time, which is detrimental to overall system efficiency.

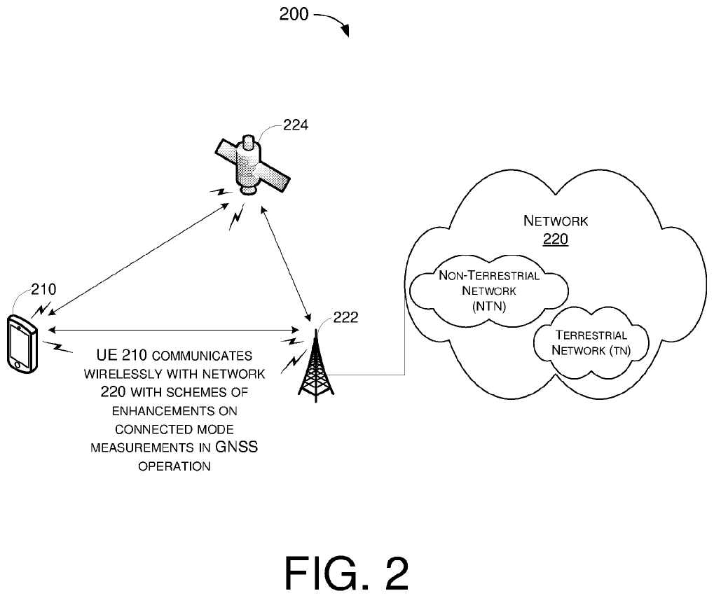

In view of the above, the present disclosure is motivated by, but not limited to, an IoT NTN scenario, and accordingly proposes a number of schemes pertaining to enhancements on connected mode measurements in GNSS operation. FIG. 2 illustrates an example scenario 200 of a communication environment in which various solutions and schemes in accordance with the present disclosure may be implemented. Scenario 200 involves a UE 210 in wireless communication with a network 220 (e.g., a wireless network including an NTN and a TN) via a terrestrial network node 222 (e.g., an evolved Node-B (eNB), a Next Generation Node-B (gNB), a transmission/reception point (TRP), or a gateway) and/or a non-terrestrial network node 224 (e.g., a (NGSO) satellite). For example, the terrestrial network node 222 and the non-terrestrial network node 224 may form an NTN serving cell for wireless communication with the UE 210. Alternatively, the non-terrestrial network node 224 may form an NTN serving cell for wireless communication with the UE 210, without involving the terrestrial network node 222. In some implementations, the UE 210 may be an IoT device, such as an NB-IoT UE or an enhanced machine-type communication (eMTC) UE (e.g., a bandwidth reduced low complexity (BL) UE or a coverage enhancement (CE) UE). In such communication environment, the UE 210, the network 220, and the terrestrial network node 222 and/or the non-terrestrial network node 224 may implement various schemes pertaining to enhancements on connected mode measurements in GNSS operation in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In general, an IoT system is mainly divided into NB-IoT and eMTC based on differences in system bandwidth and coverage. Typically, the bandwidth used in NB-IoT is about 200 kilo-hertz (KHz) and supports the transmission of low traffic data at a rate below 100 kilobits per second (Kbps). Conversely, eMTC technology typically utilizes 1.4 mega-hertz (MHz) bandwidth and the maximum data transmission rate is 1 megabits per second (Mbps).

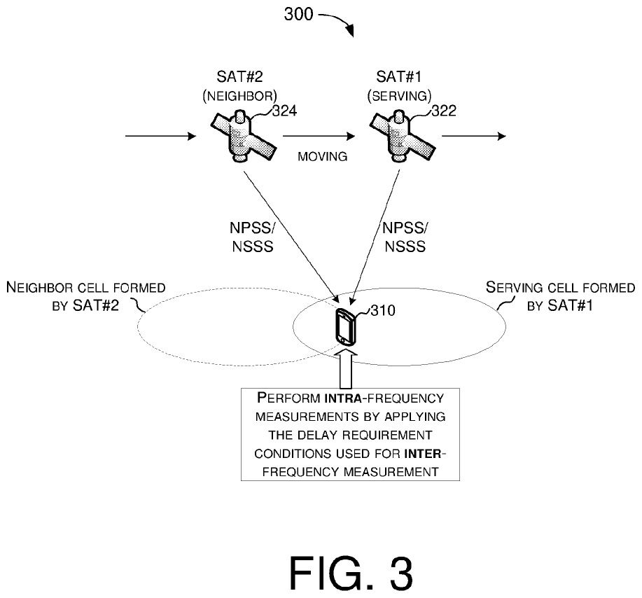

Under a first proposed scheme of the present disclosure, the UE (e.g., an NB-IoT UE in the connected mode) may perform the intra-frequency inter-satellite measurement by applying the delay requirement conditions as the “best effort manner” used for the NB-IoT inter-frequency measurement. FIG. 3 illustrates an example scenario 300 of intra-frequency inter-satellite measurement in accordance with an implementation of the present disclosure. Scenario 300 depicts a UE 310 (e.g., an NB-IoT UE) connecting to a serving cell formed by a serving satellite 322 (denoted as SAT #1) and configured to perform the intra-frequency measurement on the neighbor cell(s) formed by a neighbor satellite 324 (denoted as SAT #2). For example, the UE 310 may be provided, by the serving cell, with a configuration of the neighbor cell(s), including the identification information such as the frequency information (e.g., the absolute radio frequency channel number (ARFCN)) of the neighbor cell(s). Each of the serving satellite 322 and the neighbor satellite 324 may be an NGSO satellite which may be configured to transmit or broadcast a reference signal, such as a narrowband primary synchronization signal (NPSS) and/or a narrowband secondary synchronization signal (NSSS), and the UE 310 may detect or monitor the RS for measurement purpose. As shown in FIG. 3, in order to solve the issue of Doppler frequency shift in NTN system, the UE 310 may perform the intra-frequency inter-satellite measurement by applying the delay requirement conditions used for inter-frequency measurement.

Specifically, the UE may perform the intra-frequency measurement on the neighbor cell(s) in measurement occasions (MOs) (denoted as MO_{detect_intra_interSat}) for intra-frequency detection in a different NGSO satellite, where MO_{detect_intra_interSat} are time occasions containing an NPSS or an NSSS. More specifically, the UE may perform the intra-frequency inter-satellite neighbor cell measurements when at least one of the following conditions is met: (i) the MOs are associated with resources on which the apparatus is not scheduled for data transmission or reception; (ii) the MOs are associated with resources on which the apparatus is not required to do narrowband physical downlink control channel (NPDCCH) monitoring; (iii) the MOs are associated with resources occurring during a discontinuous reception (DRX) inactive period; and (iv) the length between the MOs is at least a period of time (e.g., at least 200 milliseconds (ms) for cell search, or at least 50 ms for cell measurement). Additionally, the UE may be able to identify a new detectable intra-frequency cell on a different NGSO satellite within an identification period, T_{identify_intra_interSat}, where T_{identify_intra_interSat} is defined to be the same as the identification period for an inter-frequency cell.

In some implementations, it is assumed that the UE may identify a new detectable intra-frequency cell within an identification period, T_{identify_intra}. In case 1-1, when the UE is monitoring intra-frequency on GSO or on the serving NGSO satellite, the identification period T_{identify_intra}=T_{detect_intra}+T_{measure_intra}, where T_{detect_intra} is 1400 ms, and T_{measure_intra} is 800 ms and 1600 ms for NRS-based measurement and NSSS-based measurement, respectively, when DRX is not used. In case 1-2, when UE is monitoring multiple carriers on GSO or on the serving NGSO satellite, the identification period T_{identify_intra}=T_{detect}+Tₘₑₐₛᵤᵣₑ, where T_{detect}=T_{detect_intra}+N_{freq}*T_{detect_inter} and Tₘₑₐₛᵤᵣₑ=T_{measure_intra}+N_{freq}*T_{measure_inter}. N_{freq} is the number of inter-frequency carriers to be measured according to the measurement capability, and T_{detect_inter} and T_{measure_inter} are defined as in inter-frequency neighbour cell measurements.

In some implementations, the identification period may be determined differently in the following cases. In case 2-1, for NGSO, when the UE is monitoring intra-frequency only on the neighbor NGSO satellite, the identification period T_{identify_intra}=T_{identify_intra_interSat}=T_{detect_intra_interSat}+T_{measure_intra_interSat}. In case 2-2, for NGSO, when the UE is monitoring intra-frequency on both the serving NGSO satellite and neighbor NGSO satellite, the identification period T_{identify_intra}=T_{detect_intra_interSat}+T_{measure_intra_interSat}+Xᵢₙₜᵣₐ, where Xᵢₙₜᵣₐ is equal to 0 if the UE is not performing intra-frequency measurements in the serving satellite, or equal to T_{identify_intra} (as in case 1-1) otherwise. In case 2-3, for NGSO, when the UE is monitoring multiple carriers on both the serving NGSO satellite and neighbor NGSO satellite, the identification period T_{identify_intra_interSat}=T_{detect_intra_interSat}+T_{measure_intra_interSat}+Xᵢₙₜᵣₐ+Xᵢₙₜₑᵣ, where Xᵢₙₜₑᵣ is equal to

$${\sum }_{i = 1}^{{N}_{freq}}$$

T_{identify_inter_NB1-NC,i}, T_{identify_inter_NB1-NC,i} is the period to identify a new detectable inter-frequency cell on carrier i, and N_{freq} is the number of inter-frequency layers monitored by the UE.

In some implementations,

$${T}_{detect \_ intra \_ interSat} = {\sum }_{i}^{N * {K}_{satellite \_ inter \_ i}}$$

Min(5000, T_{a,i}) ms, where N=70, and T_{a,i} is the interval between available measurement samples in measurement occasions (MO_{detect_intra_interSat}) for intra-frequency detection in a different NGSO satellite (e.g., 40 ms≤Tai≤5000 ms). In some implementations, T_{measure_intra_interSat} is the physical layer measurement period of NRSRP on the detected intra-frequency cell as defined below:

$${T}_{measure \_ intra \_ interSat} = {\sum }_{i}^{M * {K}_{satellite \_ inter \_ i}}$$

Min(5000, T_{b,i}) ms, where M=60 for NRS-based RRM measurement and M=40 for NSSS based RRM measurement, and T_{b,i} is the interval between available measurement samples in measurement occasions (MO_{measure_intra_interSat}) for intra-frequency measurement in a different NGSO satellite (e.g., 20 ms≤T_{b,i}≤5000 ms for NRS based measurement, or 40 ms≤T_{b,i}≤5000 ms for NSSS-based measurement).

Under a second proposed scheme of the present disclosure, if a GNSS measurement gap is configured/triggered (e.g., via a medium access control (MAC) control element (CE)), the UE (e.g., an NB-IoT UE in the connected mode) is allowed to perform the RACH procedure to indicate early termination of the GNSS measurement gap. That is, the UE may suspend all RLM/RRM measurements during the GNSS measurement gap until the UE performs the RACH procedure as an early termination of the GNSS measurement gap. In general, the RLM/RRM measurements are suspended during the GNSS measurement gap, such that the UE may perform a GNSS measurement to (re)acquire a GNSS position fix. Once the GNSS position fix is (re)acquired before the end of the GNSS measurement gap, the UE may perform the RACH procedure to indicate early termination of the GNSS measurement gap. After the RACH procedure, the UE may resume the RLM/RRM measurements if the interval between two measurement samples is not larger than 5000 ms, or restart the RLM/RRM measurements if the interval between two measurement samples is larger than 5000 ms.

In some implementations, the RACH procedure may include transmitting a random access preamble (i.e., Msg1) or a physical uplink shared channel (PUSCH) (i.e., Msg3) scheduled by a random access response (i.e., Msg2), as the early termination of the GNSS measurement gap.

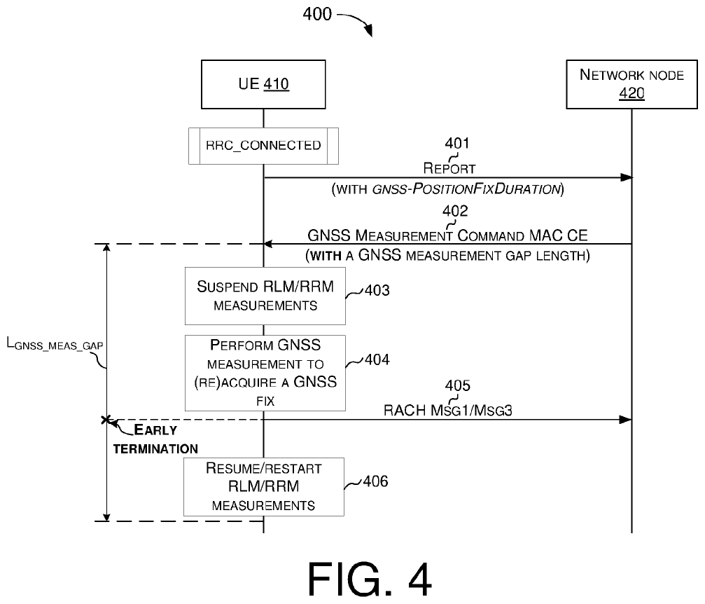

FIG. 4 illustrates an example scenario 400 of early termination of GNSS measurement gap in accordance with an implementation of the present disclosure. Scenario 400 involves a UE 410 (e.g., an NB-IoT UE) operating in RRC_CONNECTED mode to wirelessly communicate with a network node 420 of a wireless network (e.g., an NTN) under the second proposed scheme of enhancements on connected mode measurement in GNSS operation. In step 401, the UE 410 reports the time duration required for the UE to (re)acquire a GNSS position fix (denoted as gnss-PositionFixDuration) to the network node 420. For example, the time duration may be reported via an RRC message (e.g., RRC connection setup complete). In step 402, the UE 410 receives a GNSS Measurement Command MAC CE from the network node 420, which indicates the length of the GNSS measurement gap (denoted as L_{GNSS_meas_gap}). In step 403, the UE 410 suspends all RLM/RRM measurements during the GNSS measurement gap. In step 404, the UE 410 performs a GNSS measurement during the GNSS measurement gap to (re)acquire a GNSS position fix. In step 405, after the GNSS position fix is (re)acquired, the UE 410 performs a RACH procedure to indicate early termination of the GNSS measurement gap, by transmitting a Msg1 or Msg3 to the network node 420. In step 406, the UE 410 may resume or restart the RLM/RRM measurements depending on the interval between two measurement samples. If the interval between two measurement samples is not larger than 5000 ms, the UE 410 may resume the RLM/RRM measurements. Otherwise, if the interval between two measurement samples is larger than 5000 ms, the UE 410 may restart the RLM/RRM measurements.

### Illustrative Implementations

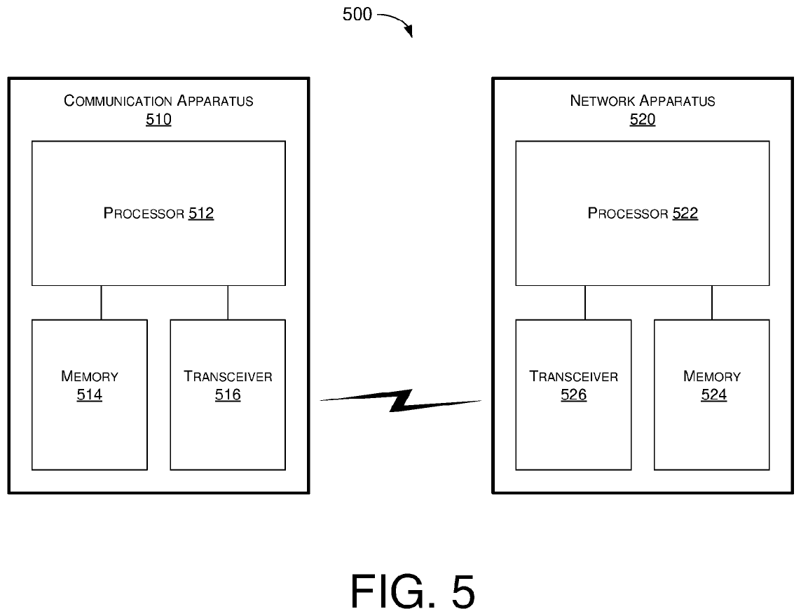

FIG. 5 illustrates an example communication system 300 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to enhancements on connected mode measurements in GNSS operation, including scenarios/schemes described above as well as process 500 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a non-terrestrial network node such as a (NGSO) satellite with/without base station (BS) functionalities, a cell, a router or a gateway of an NTN. For instance, network apparatus 520 may be implemented in a (NGSO) satellite in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including enhancements on connected mode measurements in GNSS operation, in a device (e.g., as represented by communication apparatus 510) and a non-terrestrial network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs or terrestrial network nodes (e.g., eNB/gNB/TRP) of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a non-terrestrial network node, is provided below with process 600.

### Illustrative Processes

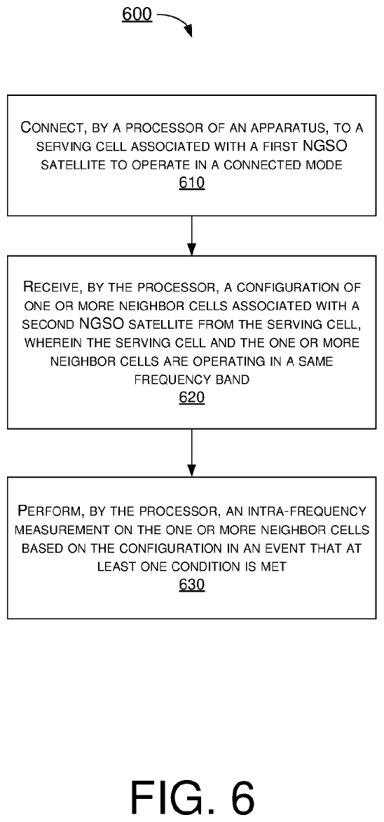

FIG. 6 illustrates an example process 600 in accordance with an implementation of the present disclosure. Process 600 may be an example implementation of above scenarios/schemes, whether partially or completely, with respect to enhancements on connected mode measurements in GNSS operation. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in communication apparatus 510 or any suitable UE or machine type devices. Solely for illustrative purposes and without limitation, process 600 is described below in the context of communication apparatus 510, as a UE. Process 600 may begin at block 610.

At block 610, process 600 may involve processor 512 of communication apparatus 510 connecting, via transceiver 516, to a serving cell associated with a first NGSO satellite to operate in a connected mode (e.g., RRC_CONNECTED mode). Process 600 may proceed from block 610 to block 620.

At block 620, process 600 may involve processor 512 receiving, via transceiver 516, a configuration of one or more neighbor cells associated with a second NGSO satellite from the serving cell, wherein the serving cell and the one or more neighbor cells are operating in a same frequency band. Process 600 may proceed from block 620 to block 630.

At block 630, process 600 may involve processor 512 performing, via transceiver 516, an intra-frequency measurement on the one or more neighbor cells based on the configuration in an event that at least one condition is met.

In some implementations, the intra-frequency measurement on the one or more neighbor cells may be performed in MOs for intra-frequency detection in a different NGSO satellite.

In some implementations, the MOs may be time occasions containing an NPSS or an NSSS

In some implementations, the at least one condition may include at least one of the following: (i) the MOs are associated with resources on which the apparatus is not scheduled for data transmission or reception; (ii) the MOs are associated with resources on which the apparatus is not required to do NPDCCH monitoring; (iii) the MOs are associated with resources occurring during a DRX inactive period; and (iv) a length between the MOs is at least a period of time.

In some implementations, the period of time may be 200 ms in an event that the intra-frequency measurement is for cell search, or may be 50 ms in an event that the intra-frequency measurement is for cell measurement.

In some implementations, the performing of the intra-frequency measurement may include identifying a detectable intra-frequency cell on the second NGSO satellite within an identification period for an inter-frequency cell.

In some implementations, process 600 may further involve processor 512 receiving, via transceiver 516, a MAC CE (e.g., a GNSS Measurement Command MAC CE) from the serving cell, wherein the MAC CE indicates that a GNSS measurement gap is triggered, and suspending all RLM or RRM measurements during the GNSS measurement gap until the apparatus performs a RACH procedure.

In some implementations, process 600 may further involve processor 512 performing, via transceiver 516, a GNSS measurement during the GNSS measurement gap to (re)acquire a GNSS fix, wherein the RACH procedure is performed to indicate an early termination of the GNSS measurement in an event that the GNSS fix is (re)acquired before an end of the GNSS measurement gap.

In some implementations, the RACH procedure may include transmitting a random access preamble, or transmitting a PUSCH scheduled by a random access response.

In some implementations, process 600 may further involve processor 512 resuming the RLM or RRM measurements after the RACH procedure in an event that an interval between two measurement samples is not larger than 5000 ms, or restarting the RLM or RRM measurements after the RACH procedure in an event that an interval between two measurement samples is larger than 5000 ms.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of an apparatus, to a serving cell associated with a first non-geostationary orbit (NGSO) satellite to operate in a connected mode;
receiving, by the processor, a configuration of one or more neighbor cells associated with a second NGSO satellite from the serving cell, wherein the serving cell and the one or more neighbor cells are operating in a same frequency band; and
performing, by the processor, an intra-frequency measurement on the one or more neighbor cells based on the configuration in an event that at least one condition is met.

2. The method of claim 1, wherein the intra-frequency measurement on the one or more neighbor cells is performed in measurement occasions (MOs) for intra-frequency detection in a different NGSO satellite.

3. The method of claim 2, wherein the MOs are time occasions containing a narrowband primary synchronization signal (NPSS) or a narrowband secondary synchronization signal (NSSS).

4. The method of claim 2, wherein the at least one condition comprises at least one of the following:
the MOs are associated with resources on which the apparatus is not scheduled for data transmission or reception;
the MOs are associated with resources on which the apparatus is not required to do narrowband physical downlink control channel (NPDCCH) monitoring;
the MOs are associated with resources occurring during a discontinuous reception (DRX) inactive period; and
a length between the MOs is at least a period of time.

5. The method of claim 4, wherein the period of time is 200 milliseconds in an event that the intra-frequency measurement is for cell search, or is 50 milliseconds in an event that the intra-frequency measurement is for cell measurement.

6. The method of claim 1, wherein the performing of the intra-frequency measurement comprises identifying a detectable intra-frequency cell on the second NGSO satellite within an identification period for an inter-frequency cell.

7. The method of claim 1, further comprising:
receiving, by the processor, a medium access control (MAC) control element (CE) from the serving cell, wherein the MAC CE indicates that a global navigation satellite system (GNSS) measurement gap is triggered; and
suspending, by the processor, all radio link monitoring (RLM) or radio resource management (RRM) measurements during the GNSS measurement gap until the apparatus performs a random access channel (RACH) procedure.

8. The method of claim 7, further comprising:
performing, by the processor, a GNSS measurement during the GNSS measurement gap to acquire a GNSS position fix, wherein the RACH procedure is performed to indicate an early termination of the GNSS measurement in an event that the GNSS position fix is acquired before an end of the GNSS measurement gap.

9. The method of claim 7, wherein the RACH procedure comprises:
transmitting a random access preamble; or
transmitting a physical uplink shared channel (PUSCH) scheduled by a random access response.

10. The method of claim 7, further comprising:
resuming, by the processor, the RLM or RRM measurements after the RACH procedure in an event that an interval between two measurement samples is not larger than 5000 milliseconds; or
restarting, by the processor, the RLM or RRM measurements after the RACH procedure in an event that an interval between two measurement samples is larger than 5000 milliseconds.

11. An apparatus, further comprising:
a transceiver which, during operation, wirelessly communicates with one or more cells; and
a processor communicatively coupled to the transceiver such that, during operation, the processor performs operations comprising:
connecting, via the transceiver, to a serving cell associated with a first non-geostationary orbit (NGSO) satellite to operate in a connected mode;
receiving, via the transceiver, a configuration of one or more neighbor cells associated with a second NGSO satellite from the serving cell, wherein the serving cell and the one or more neighbor cells are operating in a same frequency band; and
performing, via the transceiver, an intra-frequency measurement on the one or more neighbor cells based on the configuration in an event that at least one condition is met.

12. The apparatus of claim 11, wherein the intra-frequency measurement on the one or more neighbor cells is performed in measurement occasions (MOs) for intra-frequency detection in a different NGSO satellite.

13. The apparatus of claim 12, wherein the MOs are time occasions containing a narrowband primary synchronization signal (NPSS) or a narrowband secondary synchronization signal (NSSS).

14. The apparatus of claim 12, wherein the at least one condition comprises at least one of the following:
the MOs are associated with resources on which the apparatus is not scheduled for data transmission or reception;
the MOs are associated with resources on which the apparatus is not required to do narrowband physical downlink control channel (NPDCCH) monitoring;
the MOs are associated with resources occurring during a discontinuous reception (DRX) inactive period; and
a length between the MOs is at least a period of time.

15. The apparatus of claim 14, wherein the period of time is 200 milliseconds in an event that the intra-frequency measurement is for cell search, or is 50 milliseconds in an event that the intra-frequency measurement is for cell measurement.

16. The apparatus of claim 11, wherein the performing of the intra-frequency measurement comprises identifying a detectable intra-frequency cell on the second NGSO satellite within an identification period for an inter-frequency cell.

17. The apparatus of claim 11, wherein, during operation, the processor further performs operations comprising:
receiving, via the transceiver, a medium access control (MAC) control element (CE) from the serving cell, wherein the MAC CE indicates that a global navigation satellite system (GNSS) measurement gap is triggered; and
suspending all radio link monitoring (RLM) or radio resource management (RRM) measurements during the GNSS measurement gap until the apparatus performs a random access channel (RACH) procedure.

18. The apparatus of claim 17, wherein, during operation, the processor further performs operations comprising:
performing, via the transceiver, a GNSS measurement during the GNSS measurement gap to acquire a GNSS position fix, wherein the RACH procedure is performed to indicate an early termination of the GNSS measurement in an event that the GNSS position fix is acquired before an end of the GNSS measurement gap.

19. The apparatus of claim 17, wherein the RACH procedure comprises:
transmitting a random access preamble; or
transmitting a physical uplink shared channel (PUSCH) scheduled by a random access response.

20. The apparatus of claim 17, wherein, during operation, the processor further performs operations comprising:
resuming the RLM or RRM measurements after the RACH procedure in an event that an interval between two measurement samples is not larger than 5000 milliseconds; or
restarting the RLM or RRM measurements after the RACH procedure in an event that an interval between two measurement samples is larger than 5000 milliseconds.
